(19) United States
(12) Patent Application Publication
(10) Pub. No.: US 2012/0018577 A1
(43) Pub. Date: Jan. 26, 2012

(54) ENGINE MOUNTING WITH AN ADAPTED LOAD/DEFORMATION CURVE

(75) Inventor: Esteban Quiroz-Hernandez, Toulouse (FR)

(73) Assignee: AIRBUS OPERATIONS (S.A.S.), TOULOUSE (FR)

(21) Appl. No.: 13/201,781

(22) PCT Filed: Feb. 15, 2010
(86) PCT No.: PCT/FR10/50248

§ 371 Date: Oct. 12, 2011

(30) Foreign Application Priority Data
Feb. 18, 2009 (FR) 0951044

(51) Int. Cl. B64D 27/00; B23P 11/00; B64D 27/26

(52) U.S. Cl. 244/54; 29/428

(57) ABSTRACT

The invention relates to a mounting for attaching an engine to an aircraft structure, said mounting including a metal spring and being adapted for fulfilling the following conditions: the stiffness of the mounting for load values falling within a predetermined range ([CA, CB]) is less than the stiffness of the mounting for load values that fall below or above the predetermined range; considering a first load value (CS2) corresponding to a first operating mode (MF2), the load values due to dynamic variations during said first operating mode around said first value (CS2) fall within the predetermined range; the mounting comprising a means for limiting the movement of the spring with a given maximum value when applying a load with a value falling above the predetermined range ([CA, CB]).

The invention relates to the field of aeronautics. More precisely, the invention relates to a mounting capable of joining an aircraft engine to the aircraft structure, for example to a wing or to the rear fuselage. Hereinafter such a mounting will be referred to as “engine mounting”.

Ideally, an engine mounting has two functions. Firstly it must constrain the mobility of the engine relative to the aircraft structure. Secondly it must impart insulation against vibrations as well as reduction of noise.

The achievement of these two functions calls for contradictory qualities of the mounting in terms of rigidity. In fact, to achieve the function of limiting relative movements of the engine and structure of the aircraft, the mounting must be rigid, while to achieve the function of attenuating noise and vibrations, it must be flexible. This is why a compromise must generally be reached between the two functions expected of an engine mounting.

The choice of mounting also depends on the environment encountered in proximity to the engine, specific in terms of temperature, presence of chemical substances, restricted space.

Typically, rigid metal mountings are used, but they to not permit satisfactory attenuation of engine noise and vibrations.

In the case of use of flexible mountings of elastomer, insufficient resistance to the elevated temperatures and the chemical pollutions present in proximity to the engine is observed. Their useful life is greatly shortened compared with metal mountings. In addition, they must have great volume and weight in order to withstand heavy loads.

The document EP 1607330 describes a shock-absorbing device provided with a flexible assembly of stiffness K1 and with a metal spring of Belleville disk type of stiffness K2. During normal operation, the Belleville disk is inactive, shock absorption is guaranteed by the flexible assembly. When a phenomenon known as “blade off” occurs, accompanied by large oscillations of the engine, vibration damping is assured by the combination of the flexible assembly and the Belleville disk, of total stiffness K1+K2. Thus two separate systems are necessary to permit absorption of vibrations according to the type of vibrations. Furthermore, this document does not offer a compromise between the aforesaid two contradictory functions of rigidity and flexibility.

A need therefore exists for an engine mounting that makes it possible to reduce the compromise to be reached between absorption of the engine vibrations and noise on the one hand and the constraint on relative mobility of the engine and structure on the other hand, while being compatible with installation in the environment close to the engine.

According to a first aspect, the present invention proposes a mounting that comprises a metal spring and is intended to join an engine to an aircraft structure. During operation, the engine imposes loads on the mounting.

The mounting is adapted to satisfy the following conditions:
the stiffness of the mounting for load values within a specified range is lower than the stiffness for load values respectively below or above the specified range;
considering a first load value corresponding to an active mode of operation, the load values on the spring resulting from dynamic variations around the said first load value during the said first mode of operation fall within the specified range; and the mounting is provided with means that limit the displacement of the spring to a given maximum value during application of a load having a value above the specified range.

The mounting according to the invention therefore makes it possible to minimize the compromise between a permissible maximum deformation (requiring high rigidity) and effective insulation against vibrations (requiring low rigidity).

The means limiting the displacement of the spring restrict this displacement to a given maximum value during application of a load having a value above the specified range, the given maximum value being strictly lower than the maximum displacement that can nominally be achieved by the spring.

In fact, when the first mode of operation corresponds, for example, to the regular operation encountered when the aircraft is cruising, the invention makes it possible to achieve good insulation against the vibrations occurring at this regular cruising speed, while assuring good rigidity of the mounting in other modes of operation, such as acceleration toward regular cruising operation or even the cases of overload.

The use of a metal spring, by virtue of its resistance to elevated temperatures and chemical corrosion, permits the engine mounting to be used in the environment of the engine.

In one embodiment, the means limiting the displacement are provided with at least one stop limiting the displacement of the spring during application of a load having a value above the specified range.

In one embodiment, the metal spring is a metal disk spring. This type of spring occupies a very small space compared with other types of metal spring and has less weight for the same force level.

In one embodiment, the mounting is provided with stop means that prevent crushing of the spring during application of a load above the specified range. This arrangement guarantees a spring stiffness, for values of loads on the spring above the specified range, greater than the spring stiffness for load values in the specified range. This arrangement makes it possible to fix the upper value of the range. In addition, it makes it possible to increase the useful life of the mounting.

In one embodiment, the mounting is provided with a device capable of exerting a preload on the spring (of Belleville or other type), the lower value of the specified range being fixed at least by a preload exerted by this device. This arrangement contributes to the establishment of a force/displacement curve of the desired form, meaning that the desired stiffness can be fixed according to forces applied to the mounting by the engine.

In addition, this arrangement makes it possible to control the relative displacement between the engine and the structure, which is a crucial design parameter in the context of integration of the engine and structure of the aircraft. In addition, it makes it possible to increase the useful life of the mounting.

In one embodiment, this device is adapted to make the exerted preload vary according to at least one value of current static load applied to the spring, which is useful when the static load in the first mode of operation, for example during regular cruising operation, has considerable variability.

According to a second aspect, the present invention proposes a method for constructing a mounting that comprises a metal spring and is intended to join an engine to an aircraft structure, according to which
there is identified a range of load values according to an estimate of the dynamic variations around a first load value in a first active mode of operation;
the mounting is adapted so that its stiffness for load values within the said range is lower than its stiffness for load values respectively below or above this range, and so that load values corresponding to static loads during another mode of operation are respectively below or above the range.

The invention will be better understood by reading the description hereinafter and examining the accompanying figures. These figures are given by way of illustration but are in no way limitative of the invention. In these figures:

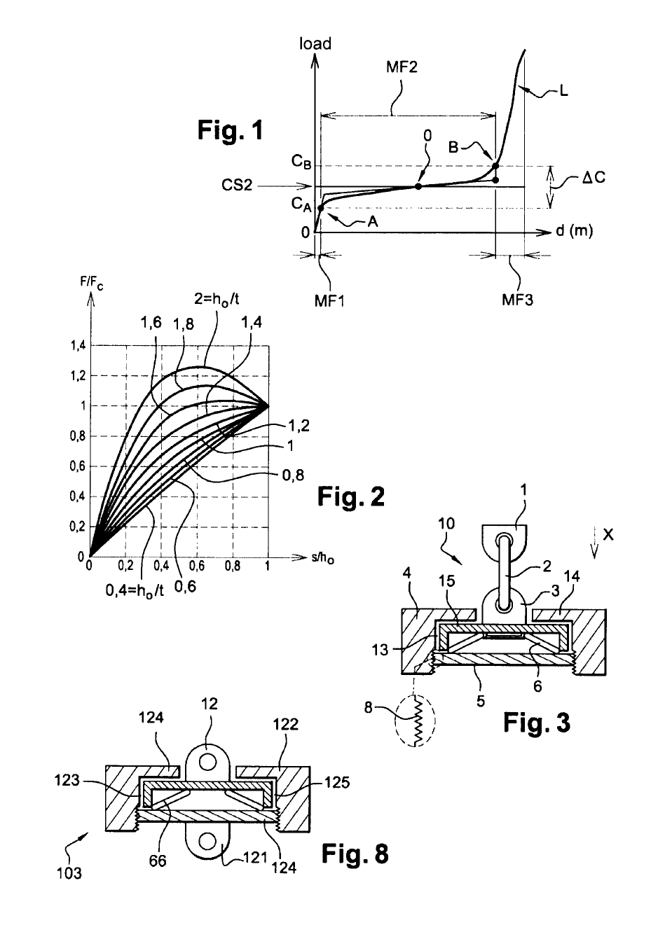

FIG. 1 represents a curve giving the relation between the load and displacement of a spring included in an engine mounting in one embodiment of the invention;

FIG. 2 shows curves of metal disk springs;

FIG. 3 represents a mounting in one embodiment of the invention;

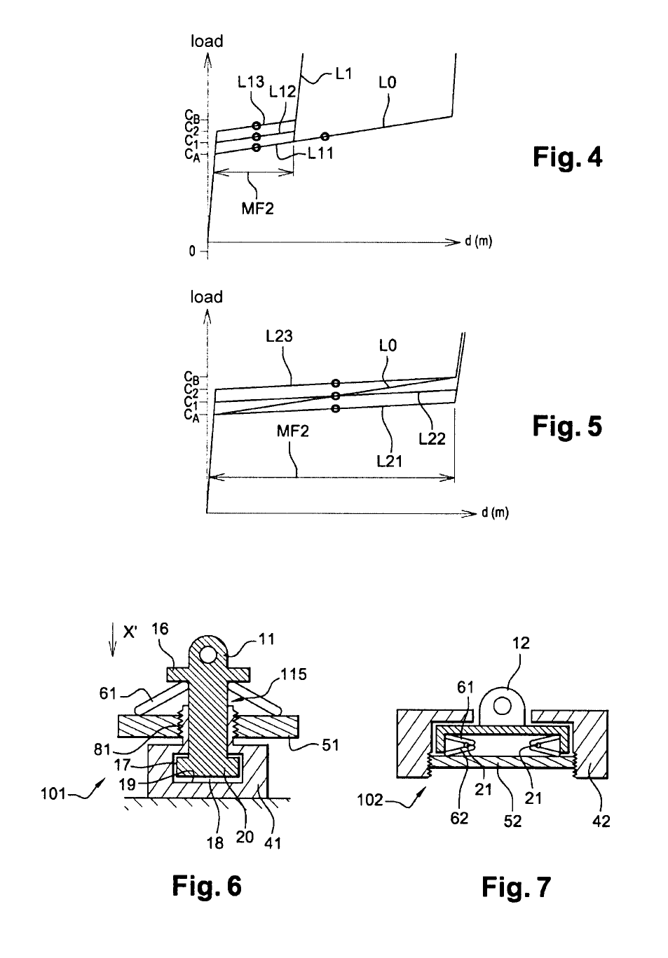

FIGS. 4 and 5 represent curves giving the relation between the load and displacement of a spring included in an engine mounting in embodiments of the invention;

FIG. 6 represents a mounting in one embodiment of the invention;

FIG. 7 represents a mounting in one embodiment of the invention;

FIG. 8 represents a mounting in one embodiment.

The present invention relates to an engine mounting intended to maintain an engine fixed to the structure of an aircraft and to transmit the normal and exceptional forces between the engine and the structure.

The engine mounting is provided with a spring that absorbs the loads that originate from the engine and have to be transmitted into the mounting.

In a preferred embodiment, the spring is a metal spring, for example a metal disk spring, especially with disks known by the name Belleville disks.

By virtue of the arrangement of elements of the mounting, the said mounting exhibits three modes of operation during operational use of the mounting.

These three modes are characterized by different stiffnesses of the mounting that identify:
a mode of reduced rigidity associated with nominal operation of the engine, referred to as mode MF2;
a first mode of elevated rigidity associated with operation with mounting loads smaller than the loads of mode MF2, referred to as mode MF1;
a second mode of elevated rigidity associated with operation with mounting loads greater than the loads of mode MF2, referred to as mode MF3.

In nominal mode of operation MF2, the load applied by the engine on the mounting lies between two extreme nominal values.

Referring to FIG. 1, these two extreme nominal values CA and CB, identified on the characteristic curve of FIG. 1 by points A and B respectively of the curve, are determined mainly by the range of dynamic variation of the forces transmitted by the mounting during nominal operation of the engine, which range may be considered to be centered on a mean value of the forces, referred to as static load CS2, corresponding to the point O of the curve, and whose variations correspond to dynamic variations of the forces around this static load CS2.

The range of dynamic variations around CS2 in mode MF2 is determined by its total amplitude ΔC.

Advantageously, the stiffness characteristics of the spring elements are determined such that the point O of the characteristic curve of the mounting corresponds to a nominal operating point of the mounting, around which effective filtration of the vibrations is desired, and such that the extreme values CA and CB determine a range of force to be transmitted by the mounting such that the superposition of the static load and of the dynamic loads whose filtration is intended falls largely between the said extreme values.

The first mode of operation at elevated rigidity MF1 is associated on the characteristic curve of the mounting with the case in which the forces to be transmitted are smaller than the lower extreme value CA of the nominal mode of operation MF2.

Such a case corresponds, for example, to a mounting that would not be under load or that would have a static load substantially smaller than CS2, for example when the engine thrust is reduced if the mounting under consideration is transmitting a thrust, a non-nominal condition for which filtration of the vibrations is not essential, for example by virtue of the small amplitude of the vibrations or of the short duration of their application, and for which the displacement of the engine must nevertheless remain limited.

The second mode of operation at elevated rigidity MF3 is associated on the characteristic curve of the mounting with the case in which the forces to be transmitted are greater than the upper extreme value CB of the nominal mode of operation MF2.

Such a case corresponds, for example, to a mounting that would be under heavy load momentarily, for example when the engine thrust is elevated during a takeoff phase or when the inertial forces are increased by virtue of a load factor, situations of short duration for which a higher vibration level is acceptable and for which the displacements of the engine must nevertheless remain limited.

The first and second modes of operation at elevated rigidity MF1 and MF3 are also employed when the dynamic loads applied to a static load of the nominal mode of operation MF1 lead to forces outside the interval of the lower and upper extreme values CA and CB of the said nominal mode, for example by virtue of vibrations of exceptionally or abnormally elevated amplitudes.

Vibrations of exceptional amplitudes are produced, for example, during flight in aerodynamic turbulences that may be normal in intensity but are encountered with sufficiently low probability that over-dimensioning of the vibration-damping capacities of the mounting is not justified.

Abnormally elevated vibrations are produced in particular in the case of severe unbalance of the engine, for example in a case of windmilling operation following a turbine blade rupture.

The spring is adapted so as to establish a curve yielding the deformation d in meters of this spring according to the load applied thereto and exhibiting the characteristics described below.

Referring to FIG. 1, the spring is rigid from the point corresponding to zero load up to point A of curve L corresponding to load CA.

The spring is flexible from point A up to point B of curve L corresponding to load CB greater than CA. It exhibits large displacements for loads applied on the spring between loads CA and CB. It therefore contributes to effective filtration of the vibrations over the range of curve L situated between loads CA and CB.

The spring is rigid beyond point B of curve L, for loads greater than CB.

In addition, the spring is adapted such that the coordinates of points A and B of load/deformation curve L are such that each load provided on the spring in mode MF2 is between CA and CB.

In one embodiment, the static load CS2 is defined as the mean value of the extreme nominal loads corresponding to points A and B.

In one embodiment, the spring is additionally adapted such that the coordinates of point A of load/deformation curve L are such that the estimated loads to which the spring is subjected in mode MF1 are smaller than CA.

In one embodiment, the spring is additionally adapted such that the coordinates of point B of load/deformation curve L are such that the estimated loads to which the spring is subjected in mode MF3 are greater than CB.

Thus the spring exhibits greatly reduced displacements for loads applied on the spring that are smaller than the load CA and for loads greater than the load CB. It therefore contributes to rigidifying the engine mounting in the case of application of such loads.

Furthermore, the spring exhibits large displacements for loads applied on the spring between loads CA and CB and therefore contributes to effective filtration of the vibrations over the range of curve L situated between loads CA and CB.

An engine mounting equipped with a spring associated with such a load/deformation curve makes it possible to minimize the compromise to be achieved between the needs of rigidity, for limiting the relative displacements between the aircraft structure (in modes of operation MF1 and MF3) and the engine, and the needs in terms of insulation of the structure against engine vibrations (in mode of operation MF2).

There exist different means for adapting a spring to make it possible to obtain an associated load/deformation curve exhibiting the desired characteristics.

As an example, one means is to exploit the intrinsic non-linear characteristics of a metal disk spring and to add at least one stop.

In fact, the load/deformation curve of a metal disk spring, for example of Belleville disk type, is non-linear by nature, and its form depends in particular on the ratio between its height and its thickness, as represented in FIG. 2, for ratio values between 0.4 and 2 (see the standard DIN 2092, “Disc Springs—Calculation”). Referring to FIG. 2, F is the load on the spring, Fc is the load on the spring when the spring is in flattened position, s is the flattening or crushing of the disk (0≦s≦h0), t is the thickness of the disk and h0 is the unladen height, not including the thickness of the disk.

In order to obtain the desired curve by exploiting these intrinsic properties of non-linearity, stop means are disposed in the mounting so as to prevent the disk spring from being compressed beyond a specified maximum compression, corresponding to a specified minimum spring height, strictly greater than the flattened position.

This last arrangement makes it possible to adjust the value CB and to obtain the load/deformation curve having the desired final form by replacing the right portion of a starting curve such as represented in FIG. 2 by a portion similar to that corresponding to loads greater than CB in FIG. 1.

Another means for obtaining the desired load/deformation curve is, for example, to preload a metal disk spring and to add at least one stop so as to prevent the disk spring from reaching the flattened position.

In such a case, the intrinsic properties of non-linearity of a metal disk spring are not exploited. It is based on the capacity of disk springs to produce large forces while occupying a limited space, to keep the mounting compact.

FIG. 3 shows a cross section through an engine mounting 10 of an aircraft in one embodiment of the invention. Mounting 10 is provided with an element 1 for attachment to the engine, a bar 2, an element 3 for attachment to structure 4 of the aircraft, a threaded base 5 and a metal disk spring 6, which in the represented case is a Belleville disk.

Structure 4 of the aircraft is provided with an inner cavity 13 overhung by an overhang 14.

Lower portion 15 of attachment element 3 is bell-shaped and is housed in inner cavity 13 of structure 4 of the aircraft.

Spring 6 is disposed between lower portion 15 of attachment element 3 and threaded base 5.

A housing is arranged in bell-shaped lower portion 15 of element 3, adapted to house spring 6 therein.

Threaded base 5 is disposed in inner cavity 13 of structure 4 of the aircraft, under spring 6. It is engaged in a screw thread 8 provided in the surface of inner cavity 13 of structure 4.

The static and dynamic loads originating from the engine are transmitted to mounting 10 by element 1 for attachment to the engine. Bar 2 guarantees that these loads are transmitted to spring 6 along a single axis X.

The preload is applied to spring 6 before operational use of the mounting, by screwing threaded base 5 into screw thread 8. This has the effect of compressing spring 6 against attachment element 3 within its lower portion 15 and against overhang 14 of structure 4 of the aircraft. In this way lower portion 15 of attachment element 3 is also pressed against overhang 14 of structure 4 of the aircraft.

The fact of preloading the spring makes it possible to define the deformation of the spring (an important parameter in the context of the design of integration of the engine in the aircraft), and especially to fix a load value CA, starting from which the spring is deformed, that is higher than the base value of the non-preloaded spring.

When the operational static load is applied (the load of value CS2 of mode MF2), element 3 for attachment to the aircraft structure no longer has to be in contact with structure 4 of the aircraft. Thus lower portion 15 of attachment element 3 is no longer braced against overhang 14 of structure 4 of the aircraft.

The operational load is then borne exclusively by spring 6. When the nominal operational load is exceeded (load larger than CB), lower portion 15 of element 3 for attachment to the aircraft structure must come into contact with threaded base 5, this arrangement thus producing a stop for spring 6, preventing greater crushing for the spring than that bounded by the inner height of bell-shaped portion 15. Spring 6 therefore cannot be compressed more than the compression corresponding to the application of load CB on the mounting. The minimum height of spring 6 during operation therefore corresponds to the height of bell-shaped portion 15.

This guarantees that mounting 10 then rigidifies the assembly of the structure and engine. The minimum load for which element 3 for attachment to the aircraft structure enters into contact with threaded base 5 corresponds to the value CB of the load/deformation curve.

The application of the preload makes it possible to guarantee that the mounting rigidifies the assembly of the structure and engine as long as a load below the range [CA, CB] is being applied.

The fatigue of the spring is limited, by virtue of the use of a preload and/or of a stop, since the deformation of the spring is limited to an interval close to the nominal operating point of load CS2.

FIG. 6 shows a cross section through an engine mounting 101 of an aircraft in another embodiment of the invention.

Engine mounting 101 is provided with an element 11 for attachment to the engine, a metal disk spring 61 (a Belleville disk in the case represented here) and a threaded base 51.

Element 11 for attachment to the engine, which joins the engine to structure 41 of the aircraft, is provided with an intermediate cylindrical portion 115 between a first end intended to be joined to the engine and containing a shoulder 16, and between a second end 20 containing a collar 17 and intended for joining with structure 41.

The static and dynamic loads originating from the engine are transmitted to mounting 101 by element 11 for attachment to the engine along an axis X′.

Spring 61 encircles cylindrical intermediate portion 115 of element 11 and its movements toward the engine along the axis X′ are limited by shoulder 16.

Structure 41 is provided with a cavity 18, which houses cylindrical intermediate portion 115 and the second end of element 11 for attachment to the engine and in this way permits a joint between element 11 for attachment to the engine and structure 41, with a relative play along the axis X′ between the movements of structure 41 and of attachment element 11.

This play is limited in one direction along the axis X′ when lower portion 20 of the second end of element 11 becomes braced on portion 19 of structure 41 bounding the lower portion of cavity 18, and in the other direction along the axis X′ when collar 17 becomes braced on the portion of structure 41 facing collar 17 along the axis X′.

The outer surface of structure 41 at the cylindrical intermediate portion 115 of element 11 has a screw thread 81, onto which threaded base 51 is screwed.

The preload on spring 61 is applied by screwing of threaded base 51 around element 11, in this way pressing spring 61 onto shoulder 16 of attachment element 11.

The function of a stop while load is being applied in compression on mounting 101 to the point and exceeding the value CB is assured by the bracing of lower portion 20 of the second end of element 11 on portion 19 of structure 41.

This embodiment is particularly advantageous in terms of space requirement.

In an embodiment represented in FIG. 7, an engine mounting 102 represented in cross section comprises an element 12 for attachment to the engine, a threaded part 52 on structure 42 of the aircraft and metal disk springs 61, 62, for example a Belleville disk. The operation of this mounting is similar to that described with reference to FIG. 3 (element 3 and structure 4 of FIG. 3 being replaced here by the single structure 42). Springs 61, 62 are disposed in stacks, so as to adjust the characteristics of the load/deformation curve and increase the flexibility of the mounting. In addition, bearing balls 21 may be added between springs 61, 62 disposed in stacks, so as to reduce the friction between these stacked springs, which friction may block the mounting in case of small dynamic loads.

In an embodiment represented in FIG. 8, in which the mounting is not housed in the structure, an engine mounting 103 represented in cross section comprises an element 12 for attachment to the engine and a peripheral element 122 defining an inner housing 123 overhung by a collar 124 disposed around element 12 for attachment to the engine.

The inner portion of peripheral element 122 is provided with a screw thread in which there is engaged a threaded base 124, which is prolonged in its lower portion by an element 121 for attachment to the structure.

Element 12 for attachment to the engine is prolonged in its lower part by a bell-shaped element 125, which is housed in housing 123.

A metal spring 66 is disposed between threaded base 124 and bell-shaped element 125.

The operation is similar to that described hereinabove with reference to FIG. 3. In one embodiment of the invention, the preload level is adapted during flight of the aircraft in mode MF2, which is particularly useful when the operational static load exhibits large variations. The adaptation of the preload level is accomplished, for example, by means of a servo motor or of a piston, which in the cases described with reference to FIGS. 3 and 7 makes it possible to tighten or loosen the threaded base.

The adaptation of the preload level may be exploited in two distinct ways. In mode MF2, it may permit reduction of the deformation range of the spring while retaining the same rigidity of the spring, or else reduction of the rigidity while retaining the same deformation range of the spring.

FIG. 4 shows load/deformation curves L0 and L1 for a spring of an engine mounting. L0 is the curve of an engine mounting according to the invention, for example of the type represented in FIG. 3, without adaptation of the preload level according to the current static load.

L1 is the curve obtained for the same engine mounting in which the applied preload is adapted according to the current static load, measured in real time in mode of operation MF2. Thus three different preload levels are applied to the spring of the mounting according to the value of the current static load, corresponding to the three portions L11, L12 and L13 of curve L1.

When the measured current static load is between CA and C1, the portion of load/deformation curve L1 of the mounting is L11.

When the measured current static load is between C1 and C2, the portion of load/deformation curve L1 of the mounting is L12.

When the measured current static load is between C2 and CB, the portion of load/deformation curve L1 of the mounting is L13.

FIG. 5 represents load/deformation curves L0 and L2 for a spring of an engine mounting. L0 is the curve of an engine mounting according to the invention, for example of the type represented in FIG. 3, without adaptation of the preload level according to the current static load.

L2 is the curve obtained for the same engine mounting in which the applied preload is adapted according to the current static load, measured in real time in mode of operation MF2. Thus three different preload levels are applied according to the value of the current static load, corresponding to the three portions L21, L22 and L23 of curve L2.

When the measured current static load is between CA and C1, the portion of load/deformation curve L1 of the mounting is L21.

When the measured current static load is between C1 and C2, the portion of load/deformation curve L1 of the mounting is L22.

When the measured current static load is between C2 and CB, the portion of load/deformation curve L1 of the mounting is L23.

The invention is particularly advantageous when the ratio between the dynamic variations of load around the static load and the static load itself is small, which is the case of the load applied to the engine mountings during cruising operation.

1. A mounting (10) intended to join an engine to an aircraft structure, the said mounting comprising a metal spring (6) and being adapted to satisfy the following conditions:
the stiffness of the mounting for load values within a specified range ([CA, CB]) is lower than the stiffness for load values respectively below or above the specified range, the stiffness of the mounting being a function of the stiffness of the spring for load values within the specified range ([CA, CB]) and for load values below and above the specified range;
considering a first load value (CS2) corresponding to a first mode of operation (MF2), the load values resulting from dynamic variations around the said first value (CS2) during the said first mode of operation fall within the specified range;
the mounting is provided with means that limit the displacement of the spring to a given maximum value during application of a load having a value above the specified range ([CA, CB]).

2. A mounting (10) according to claim 1, wherein the means limiting the displacement are provided with at least one stop (15, 5) limiting the displacement of the spring (6) during application of a load having a value above the specified range ([CA, CB]).

3. A mounting (10) according to claim 1 or 2, wherein the metal spring (6) is a disk spring.

4. A mounting (10) according to one of claims 1 to 3, provided with a device (5) capable of exerting a preload on the spring (6), the lower value (CA) of the predetermined range ([CA, CB]) being fixed at least by a preload exerted by the said device.

5. A mounting (10) according to claim 4, wherein the device (5) capable of exerting a preload is adapted to make the exerted preload vary according to at least one value of current static load applied to the spring (6).

6. A method for constructing a mounting (10) that comprises a metal spring (6) and is intended to join an engine to an aircraft structure, according to which
there is identified a range of load values ([CA, CB]) according to an estimate of the dynamic variations around a first load value (CS2) in a first active mode of operation (MF2);
the mounting is adapted so that its stiffness for load values within the said range is lower than its stiffness for load values respectively below or above the said range, and so that load values corresponding to static loads during at least one other mode of operation are respectively below or above the said range, the stiffness of the mounting being a function of the stiffness of the spring for load values within the specified range ([CA, CB]) and for load values below and above the specified range.

7. A method according to claim 6, according to which the mounting is provided with means limiting the displacement of the spring to a given maximum value during application of a load having a value above the specified range ([CA, CB]).

8. A method according to claim 6 or 7, according to which the upper value of the range (CB) is fixed according to at least the positioning on the mounting of means (5, 15) of at least one stop (15, 5) limiting the displacement of the spring (6) during application of a load having a value above the specified range ([CA, CB]).

9. A method according to any one of claims 6 to 8, according to which the lower value (CA) of the range is fixed according to at least one preload exerted on the spring.

10. A method according to claim 9, according to which the exerted preload is modified according to at least one value of current static preload applied to the spring (6).
